(19) United States
(12) Patent Application Publication
(10) Pub. No.: US 2025/0033923 A1
(43) Pub. Date: Jan. 30, 2025

(54) FESTOON FORM TAPE PACKAGING

(71) Applicant: 3M INNOVATIVE PROPERTIES COMPANY, St. Paul, MN (US)

(72) Inventors: Jesse R. Behnke, Maplewood, MN (US); Randall S. Teare, Inver Grove Heights, MN (US); Timothy L. Hoopman, River Falls, WI (US)

(21) Appl. No.: 18/713,920

(22) PCT Filed: Dec. 14, 2022
(86) PCT No.: PCT/IB2022/062223

§ 371 Date: May 28, 2024

Related U.S. Application Data
(60) Provisional application No. 63/289,678, filed on Dec. 15, 2021.

(51) Int. Cl. B65H 75/06; E01F 9/512

(52) U.S. Cl. CPC B65H 75/06; E01F 9/512

(57) ABSTRACT

A packaged tape includes a tape having a length, such as a pavement marking tape having a base tape, adhesive, and liner. The tape includes a first end and a second end opposite the first end. The tape is folded in a festoon form arrangement with the second end of the tape being available to be joined to a first end of another tape folded in the festoon form arrangement. While the packaged tape is being dispensed and applied, or before such, the second end can be spliced to an end of another packaged tape in the festoon form arrangement.

### BACKGROUND

Pavement marking tapes are applied from rolls, and the end of each roll must be spliced to the next roll to continue application of the tapes. Splicing of the pavement marking tapes during field installation represents a long-known and significant productivity hurdle for the installation contractor. Application equipment can be used that reduces, but does not eliminate, the need to stop the operation to make a splice. Stopping the operation to apply pavement marking results in down time and lost productivity for the contractor. Other application equipment is designed to allow continuous application from roll-based packaging, but it is sophisticated and expensive. Accordingly, a need exists for a different type of tape packaging, particularly for pavement marking tape.

### SUMMARY

A pavement marking tape comprises the tape packaged in a festoon form arrangement.

A packaged tape includes a tape having a length. The tape includes a first end and a second end opposite the first end. The tape is folded in a festoon form arrangement, and the second end of the tape in the festoon form arrangement is available to be joined to a first end of another tape folded in the festoon form arrangement.

A pavement marking tape package includes a tape having a first end and a second end opposite the first end. The second end is prepared to be spliced to a first end of another pavement marking tape.

### BRIEF DESCRIPTION OF THE DRAWINGS

FIG. 1 is a diagram of tape with a liner packaged in a festoon form.

FIG. 2 illustrates the splicing of tape between two packages while tape from one of the packages is being dispensed.

FIG. 3 illustrates that, with a splice made between packages, the stacks of tape in festoon form can be pushed together.

FIG. 4 illustrates that, with one stack running out of tape, a transition to another stack occurs uninterrupted.

FIG. 5 illustrates that the process to splice tape between packages can be repeated with a third stack after completely dispensing a first stack with the first and second stacks spliced together.

FIG. 6 illustrates creating a large buffer of spliced together packages of tape.

FIG. 7 illustrates hinge elements in a package of tape.

FIG. 8 illustrates two separate tape ends to be spliced together in a first embodiment.

FIG. 9 illustrates the two tape ends being secured together with a contact adhesive film in the first embodiment.

FIG. 10 illustrates the contact adhesive film starting to be removed in the first embodiment.

FIG. 11 illustrates the contact adhesive film being further removed to secure the two ends together in the first embodiment.

FIG. 12 illustrates two separate tape ends to be spliced together in a second embodiment.

FIG. 13 illustrates the two tape ends being secured together in the second embodiment.

FIG. 14 illustrates a paper liner starting to be removed in the second embodiment.

FIG. 15 illustrates the paper liner being fully removed to secure the two ends together in the second embodiment.

### DETAILED DESCRIPTION

Embodiments can be used with pavement marking tape, or other types of tape, to add a “no-stop” splicing feature to the tape packaging. This feature can make contractors more productive in applying pavement marking tape. This feature can also enable a full “rolling closure” tape installation and can reduce the need to control the application equipment along with the expense of doing so.

### Festoon Form Packaging

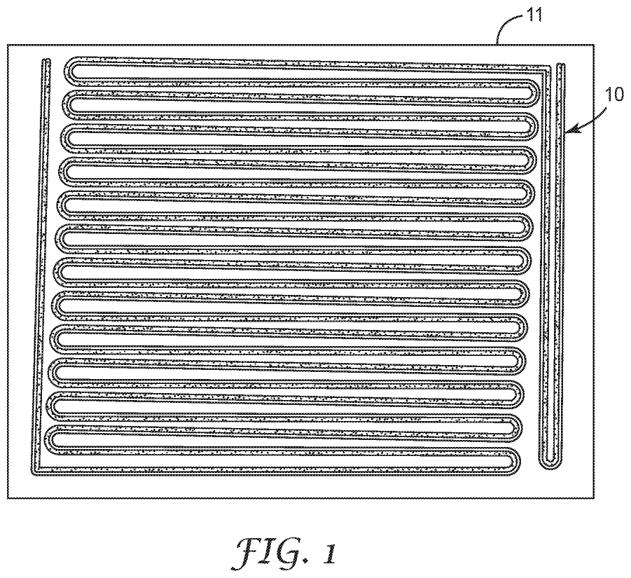

Embodiments include packaging a tape, with a liner, in a festoon form. FIG. 1 is a diagram of a tape 10 with a liner and adhesive packaged in a festoon form arrangement. The tape can be within a container 11 such as a cardboard box, shrink-wrap, straps, rubber bands, or other containers used to secure the tape when in festoon form arrangement. The tape typically has a continuous length in the package. In some embodiments, the tape can have discrete regions connected to one another.

The festoon form arrangement is a zig zag web or folded arrangement providing access to both ends of the tape while in the festoon form arrangement. Being accessible in the festoon form arrangement means that the ends are available for being spliced to another tape. In comparison, in a roll of tape, the end at the center of the roll is not accessible until the tape is completely unrolled. In one example, the tape is a pavement marking tape having a length up to 120 yards long and a width of four inches. Other pavement marking tapes can have a width of, for example, 4, 6, 7, 8, 9, 10, 12, or 16 inches.

In some embodiments, the pavement marking tape has a first end and a second end opposite the first end, and both the first and second ends are accessible while the tape is substantially packaged, for example packaged with the ends extending outside the box or accessible through the box

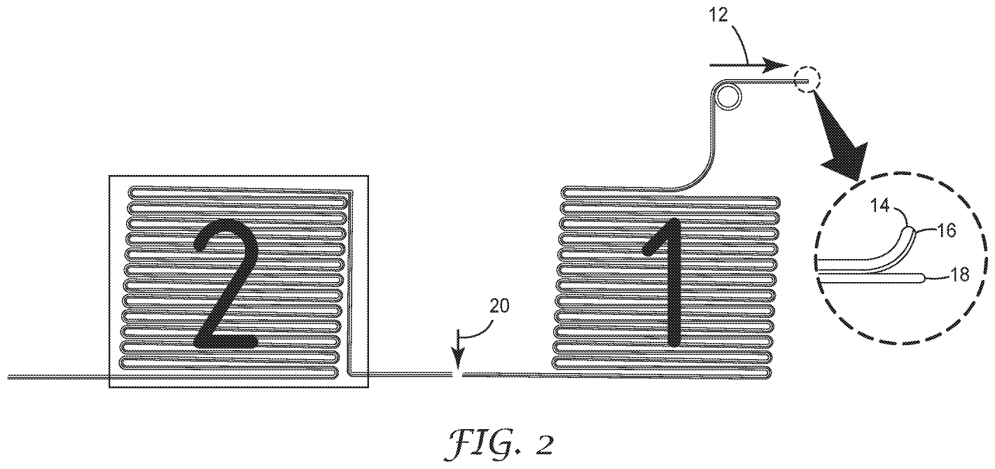

FIG. 2 illustrates the splicing of tape between two packages. both in festoon form arrangement. while tape from one of the packages is being dispensed. In particular, package 1 is being dispensed. and its leading end is being pulled by tape feeding application head 12 having an unwind mandrel as illustrated underneath the leading end. Application head 12 can be designed and/or modified to receive and use pavement marking tape packaged in a festoon form arrangement. In some embodiments. the tape application device (12) does not have an unwind mandrel or does not use its unwind mandrel during application.

The tape can include, as shown at a first end. a base tape 14. for example a pavement marking tape. an adhesive 16, and a liner 18. In some embodiments. adhesive 16 is optional and. in that case. liner 18 is not needed. When applied to a surface. liner 18 is removed to expose adhesive 16 and secure base tape 14 to the surface. Package 2 container is opened and both ends tipped out. A splice 20 can then be made between packages 1 and 2. In particular. a second end of package 1 can be spliced (20) to a first end of package 2. where the first end of package 2 is optionally prepared for splicing. Examples of prepared tape ends for splicing are provided below. Other examples of end preparations include a contact adhesive element and a pressure sensitive adhesive. Both the tape and the liner are spliced separately. A “prepared” end is a modification to the end of pavement marking tape that facilitates splicing beyond a conventional perpendicular cut of the tape. This may include the addition or omission of a layer or layers. different geometry. thicknesses. or materials distinctive from the material in the rest (non-end portion) of the tape bulk.

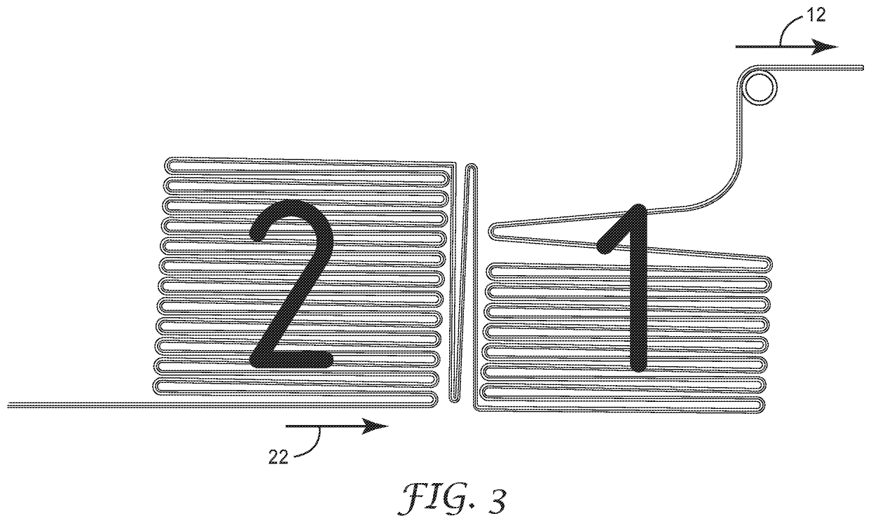

FIG. 3 illustrates that. with a splice made between packages 1 and 2. the stacks of tape in festoon form can be pushed together. as illustrated by arrow 22. Package 2 is now ready for another splice.

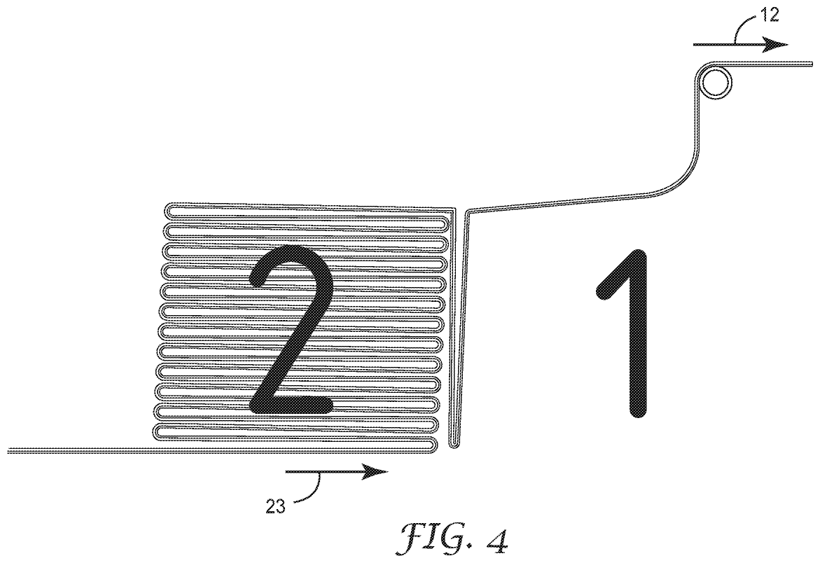

FIG. 4 illustrates that. with package 1 running out of tape. a transition to package 2 occurs uninterrupted. and package 2 is pushed over toward tape feeding application head 12. as illustrated by arrow 23.

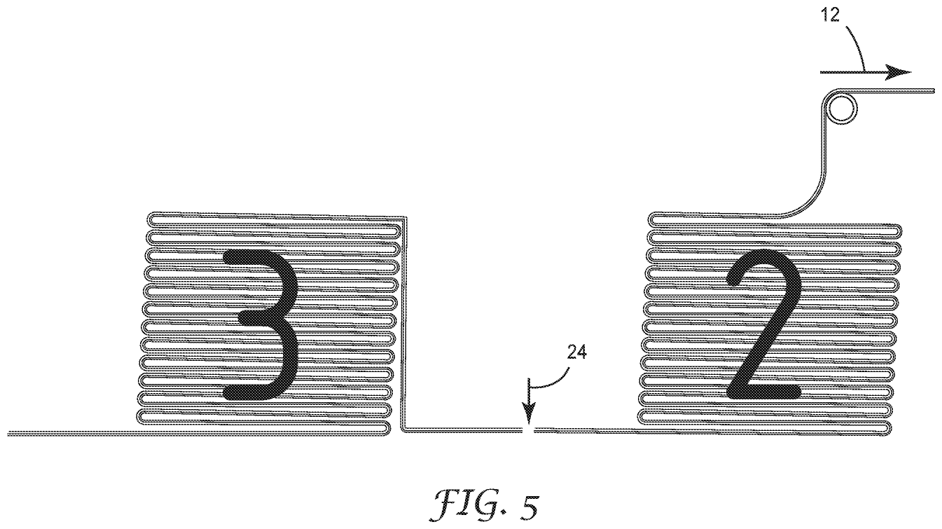

FIG. 5 illustrates that the process to splice tape between packages can be repeated with a third stack. package 3 having tape in festoon form arrangement. after completely dispensing package 1 with the packages 1 and 2 spliced together. A splice 24 can then be made between packages 2 and 3.

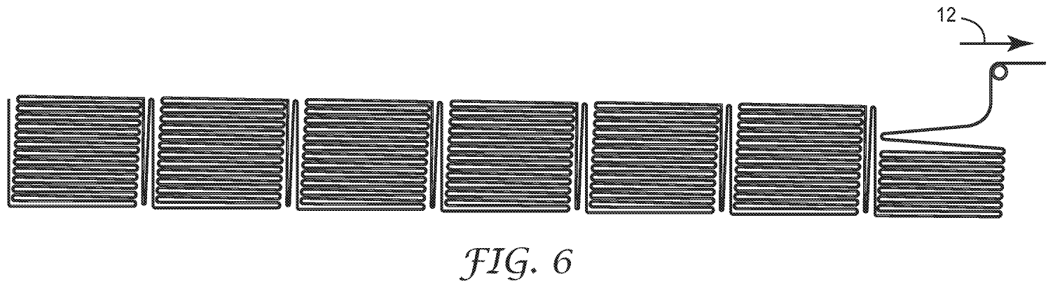

FIG. 6 illustrates creating a large buffer of spliced together packages of tape with each of the packages having tape in festoon form arrangement. For example. during down-time a contractor can splice multiple rows together to create a buffer. in this example six packages spliced together following the first package being fed out.

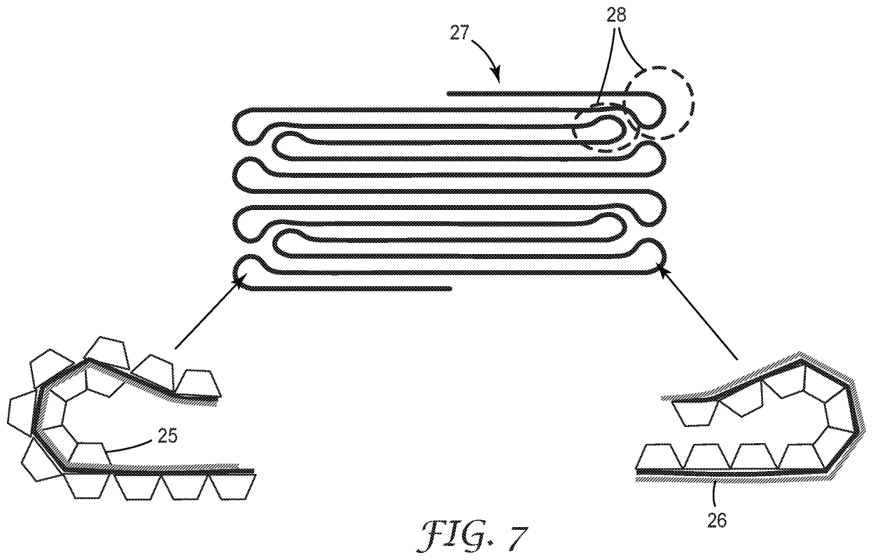

FIG. 7 illustrates hinge elements in a package of tape in festoon form arrangement. A hinge element is a radius controlling feature. A package 27 of tape in festoon form can include misalignment of the bends to allow larger bend radii while maintaining packing density. as illustrated by bends 28. Also. hinge elements can be used to prevent crimping of the tape in the bends. A hinge element 25 can be located on the inside of a bend and secured against a liner for the tape. Pavement marking tape can have bumps referred to as “plateaus,” which would control the radius when bending toward the plateaus. but bending in the other direction does not have this benefit and the radius would be much tighter—hence the radius controlling features are added to the liner. A hinge element 26 can be located on the outside of a bend and secured against a liner for the tape. Hinge elements 25 and 26 function as a radius controlling feature on the liners to avoid high stresses on the tape or crimping of it. Hinge elements 25 and 26 can be configured with elements that restrict or control a radius of the bends and do not allow the bend beyond a particular radius value. A hinge element can optionally be located at a position where the backing for the pavement marking tape is made thinner or a position where certain layers of the tape are omitted. Since hinge elements 25 and 26 are adhered or otherwise secured to the liners. hinge elements 25 and 26 are removed from the tape when the liners are removed. The hinge elements can also be integrated into the tape construction.

### Splicing Methods

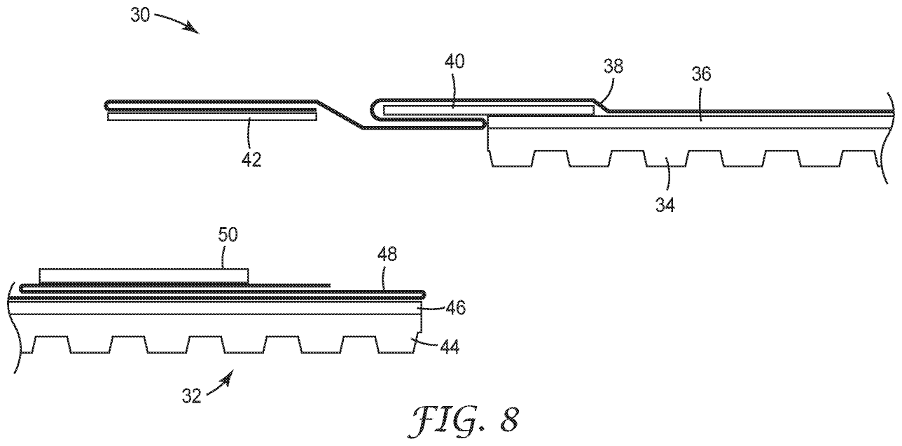

FIGS. 8-11 illustrate a first splicing method and configuration of tape ends for the splicing. FIG. 8 illustrates two separate tape ends to be spliced together. for example between two packages of tape in festoon form arrangement as described above. A first tape end 30 includes a backing 34 (e.g., pavement marking tape), an adhesive 36, a liner 38, a two-sided tape 40, and a contact adhesive film 42. A contact adhesive film in non-tacky to the touch but sticks strongly to itself. Instead of a contact adhesive film. a hook and loop mechanical fastener could be used. Two-sided tape 40 is held between liner 38 and a portion of adhesive 36. and two-sided tape 40 extends beyond an edge of tape end 30. Contact adhesive film 42 is on an exposed end of liner 38.

A second tape end 32 includes a backing 44 (e.g., pavement marking tape), an adhesive 46. a liner 48, and a contact adhesive film 50. Contact adhesive film 50 has a first side on a folded portion of liner 48 and an exposed second side opposite the first side. Liners 38 and 48 can be the same liner as in the one in the bulk of the pavement marking tape or a different liner.

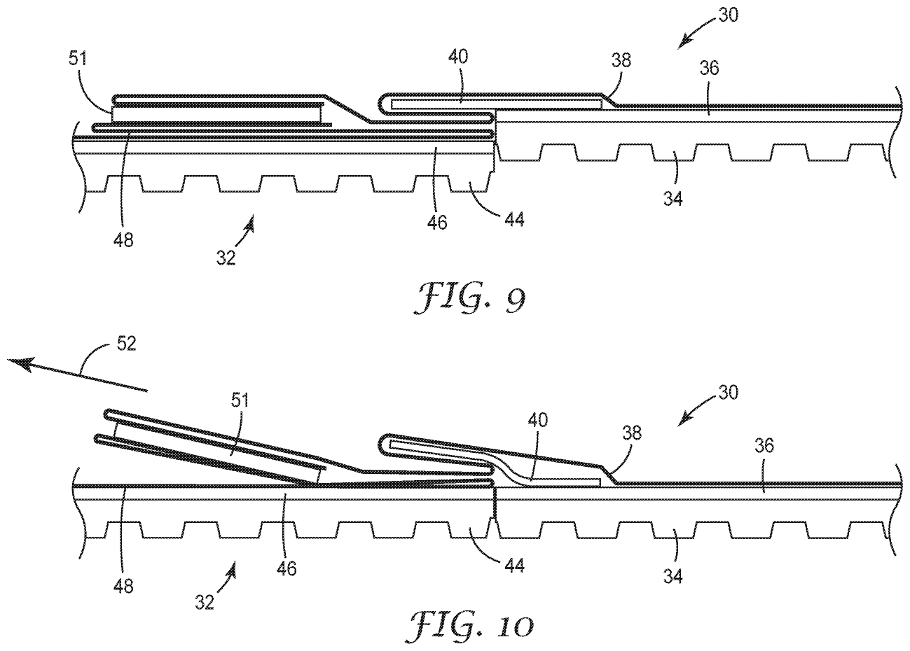

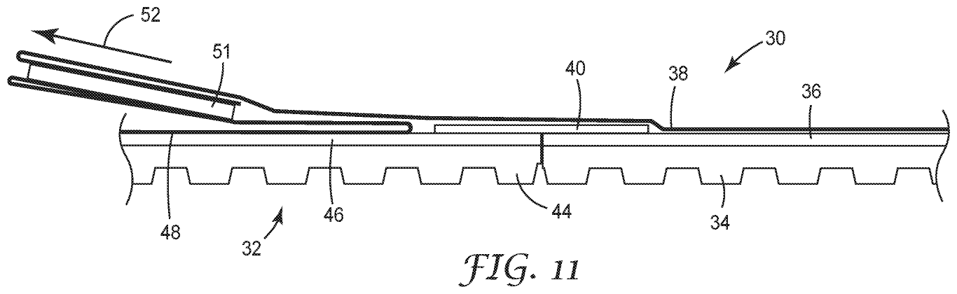

FIG. 9 illustrates the two tape ends 30 and 32 being secured together with a contact adhesive film 51 composed of contact adhesive films 42 and 50 being secured together. FIG. 10 illustrates contact adhesive film 51 starting to be removed, as illustrated arrow 52. FIG. 11 illustrates contact adhesive film 51 being further removed, as illustrated by arrow 51, to secure together the two ends 30 and 32 via two-sided tape 40.

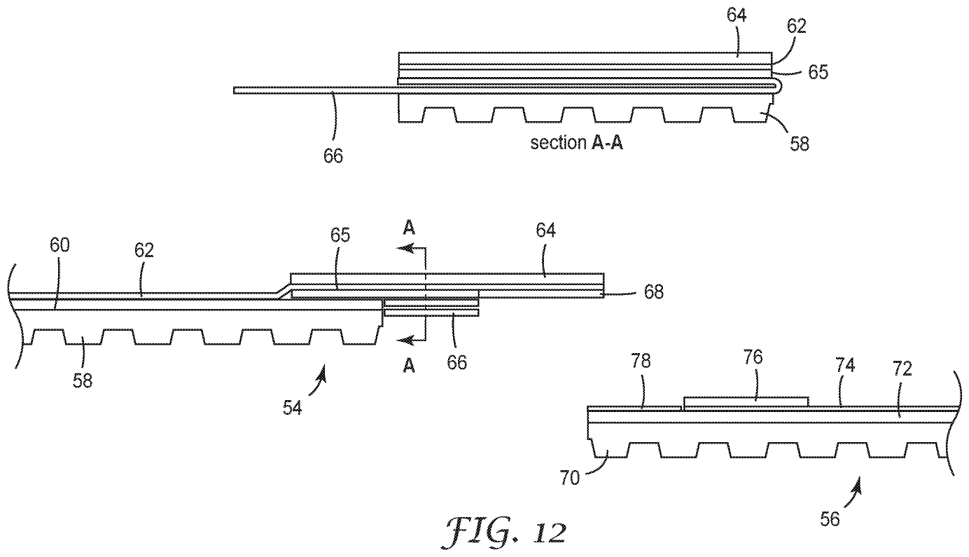

FIGS. 12-15 illustrate a second splicing method and configuration of tape ends for the splicing. FIG. 12 illustrates two separate tape ends to be spliced together, for example between two packages of tape in festoon form arrangement as described above. A first tape end 54 includes a backing 58 (e.g., pavement marking tape), an adhesive 60, a liner 62, a stiffener 64, a two-sided tape 65, a paper liner 66, and a contact adhesive film 68. Contact adhesive film 68 has a first side on liner 62 and has a second exposed side opposite the first side, and contact adhesive film 68 is located spaced apart from an edge of tape end 54. Two-sided tape 65 is on a same side of liner 62 as contact adhesive film 68 and is located extending over an edge of tape end 54. Paper liner 66 is on a side of two-sided tape 65 opposite liner 62 and is located at the end of tape end 54. Stiffener 64 is on a side of liner 62 opposite two-sided tape 65 and contact adhesive film 68.

A second tape end 56 includes a backing 70 (e.g., pavement marking tape), an adhesive 72, a liner 74, a contact adhesive film 76, and a primed PET (polyethylene terephthalate) 78. Contact adhesive film 76 has a first side on adhesive 72 and has a second exposed side opposite the first side.

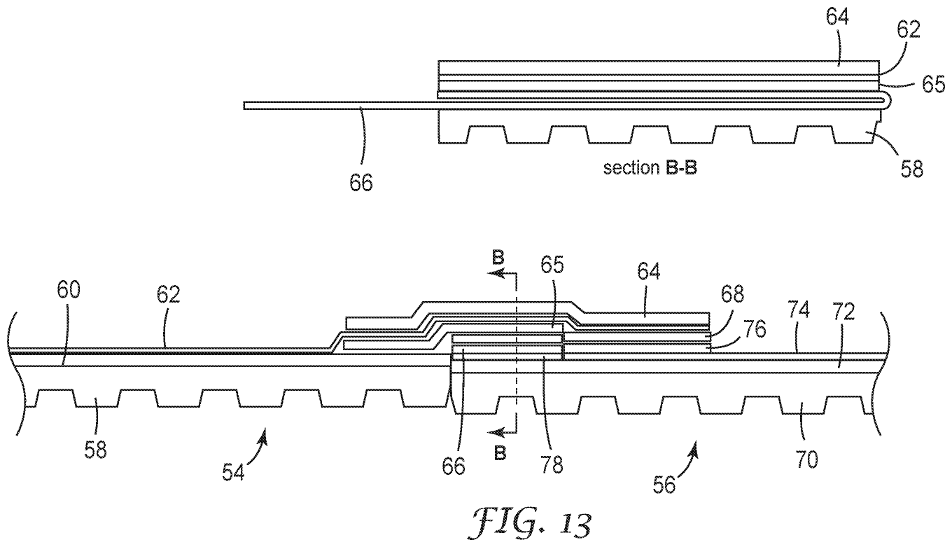

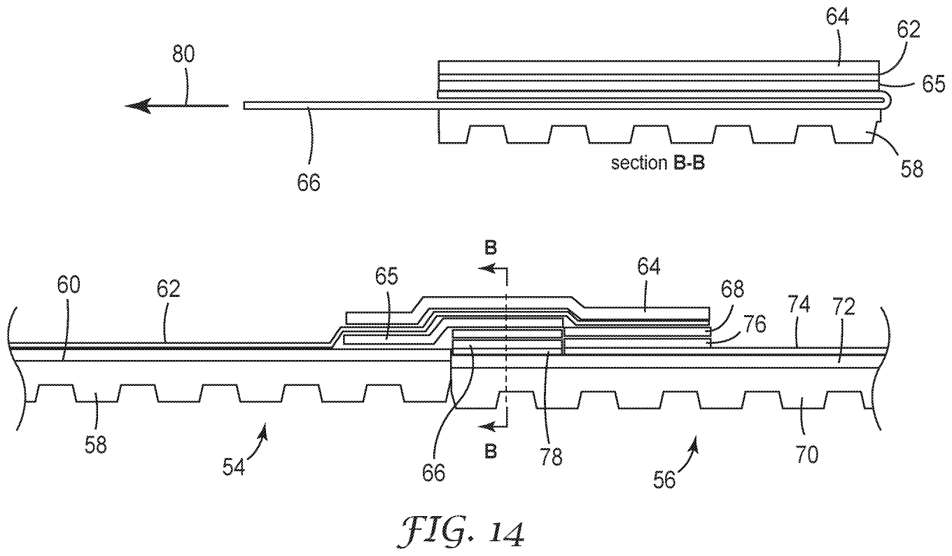

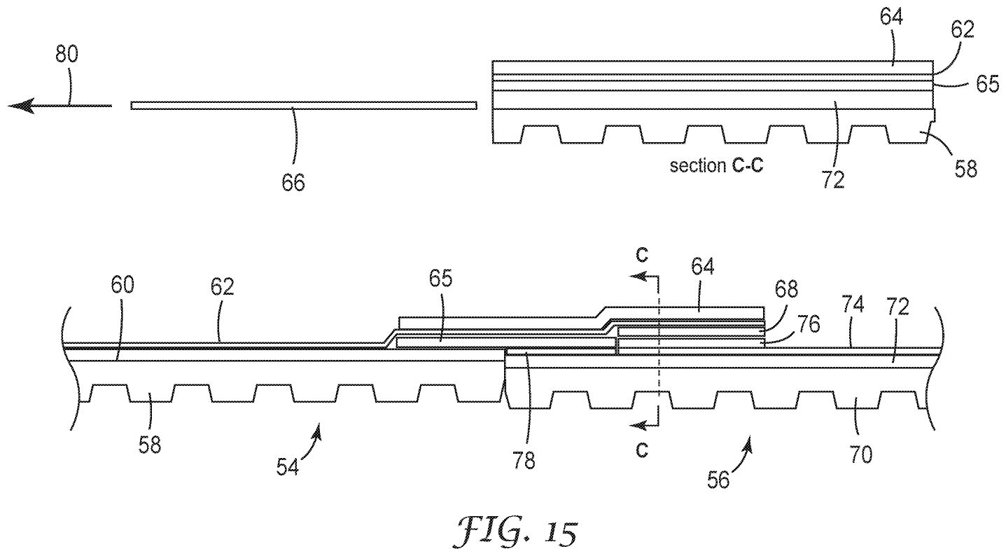

FIG. 13 illustrates the two tape ends 54 and 56 being secured together with contact adhesive films 68 and 76, and also illustrating paper liner 66 placed against primed PET 78. FIG. 14 illustrates paper liner 66 starting to be removed. Paper liner 66 is removed laterally or in a substantially perpendicular direction from the tape ends 54 and 56. FIG. 15 illustrates paper liner 66 being fully removed to secure the two ends 54 and 56 together via two-sided tape 65 adhered to primed PET 78. In FIGS. 13-15, Section B-B and Section C-C are shown as partial cross-sections for illustrative purposes.

Other splicing methods and configurations are possible between two packages of tape in festoon form arrangement.

As an alternative, both ends of a pavement marking tape can be prepared for splicing, as described with respect to FIGS. 8-15 or in other ways, and such tape with prepared ends can be stored in a conventional roll form. Once the pavement marking tape is unrolled, the end inside of the roll is already prepared for splicing.

1-3. (canceled)

4. A pavement marking tape, comprising the tape packaged in a festoon form arrangement, further comprising a hinge element located on an inside or an outside of at least one bend in the packaged tape, wherein the hinge element controls a radius of the bend.

5-8. (canceled)

9. A pavement marking tape, wherein the tape has a first end and a second end opposite the first end, and both the first and second ends are accessible while the tape is substantially packaged, wherein the second end is prepared to be spliced to a prepared first end of another pavement marking tape.

10. The pavement marking tape of claim 9, wherein at least one of the prepared first and second ends has a contact adhesive element.

11. The pavement marking tape of claim 9, wherein at least one of the prepared first and second ends has a pressure sensitive adhesive.

12. The pavement marking tape of claim 9, wherein the second end comprises:
a two-sided tape held between a liner and a portion of an adhesive; and
a contact adhesive film on an exposed end of the liner.

13. The pavement marking tape of claim 12, wherein the prepared first end of the another pavement marking tape comprises another contact adhesive film having a first side on a folded liner and having an exposed second side opposite the first side,
wherein at least partial removal of the contact adhesive film with the another contact adhesive film secures together the second end and the prepared first end via the two-sided tape.

14. The pavement marking tape of claim 9, wherein the second end comprises a contact adhesive film having a first side on an adhesive and having a second exposed side opposite the first side.

15. The pavement marking tape of claim 14, wherein the prepared first end of the another pavement marking tape comprises:
a contact adhesive film having a first side on a liner and having a second exposed side opposite the first side, wherein the contact adhesive film is located spaced apart from an edge of the prepared first end;
a two-sided tape on a same side of the liner as the contact adhesive film and located extending over an edge of the first end;
a liner on a side of the two-sided tape opposite the liner and located at the end of the first end; and
a stiffener on a side of the liner opposite the two-sided tape and the contact adhesive film,
wherein removal of the liner secures together the second end and the prepared first end via the two-sided tape.

16. (canceled)

17. A packaged tape, comprising:
a tape having a length,
wherein the tape comprises a first end and a second end opposite the first end,
wherein the tape is folded in a festoon form arrangement, and the second end of the tape in the festoon form arrangement is available to be joined to a first end of another tape folded in the festoon form arrangement.

18. The packaged tape of claim 17, wherein the tape comprises a pavement marking tape having a base tape, a liner, and an adhesive between the base tape and the liner.

19. The packaged tape of claim 17, wherein the festoon arrangement includes misalignment of bends in the folded tape.

20. The packaged tape of claim 17, further comprising a hinge element located on an inside of at least one bend in the folded tape, wherein the hinge element controls a radius of the bend.

21. The packaged tape of claim 20, wherein the hinge element is secured against a liner for the tape.

22. The packaged tape of claim 17, further comprising a hinge element located on an outside of at least one bend in the folded tape, wherein the hinge element controls a radius of the bend.

23. The packaged tape of claim 22, wherein the hinge element is secured against a liner for the tape.

24. The packaged tape of claim 17, wherein the second end is prepared to be spliced to a prepared first end of another pavement marking tape.

25. The packaged tape of claim 24, wherein the second end comprises:
a two-sided tape held between a liner and a portion of an adhesive; and
a contact adhesive film on an exposed end of the liner.

26. The packaged tape of claim 25, wherein the prepared first end of the another pavement marking tape comprises another contact adhesive film having a first side on a folded liner and having an exposed second side opposite the first side,
wherein at least partial removal of the contact adhesive film with the another contact adhesive film secures together the second end and the prepared first end via the two-sided tape.

27. The packaged tape of claim 24, wherein the second end comprises a contact adhesive film having a first side on an adhesive and having a second exposed side opposite the first side.

28. (canceled)

29. The packaged tape of claim 17, further comprising a container, wherein the packaged tape is within the container.

30-37. (canceled)
